(19) United States
(12) Patent Application Publication
(10) Pub. No.: US 2008/0185237 A1
(43) Pub. Date: Aug. 7, 2008

(54) Dual bicycle braking system

(76) Inventor: Andy Moon, Stevenson Ranch, CA (US)

Correspondence Address: Andy Moon, 25132 Steinbeck Ave. #A, Stevenson Ranch, CA, 91381, US

(21) Appl. No.: 11/702,401

(22) Filed: Feb. 6, 2007

(51) Int. Cl. B62L 3/00

(52) U.S. Cl. 188/24.21

(57) ABSTRACT

A dual bicycle braking system for applying greater braking force to the front wheel of a bicycle than to the back wheel, the system having front and rear brakes controlled by front and rear hand brake levers, the rear lever operationally secured to a singular rear caliper break, the front brake lever operationally secured to a primary cable, which in turn is secured to first and second actuating cables, the first actuating cable operates a first caliper brake and the second actuating cable operates a second caliper brake, both of which engage the front wheel of the bicycle to apply greater braking force to the front wheel than is applied to rear wheel by the rear caliper brake, the first actuating cable may be shorter than the second actuating cable so that the first caliper brake engages the front wheel before the second caliper brake does to provide graduated de-acceleration, or alternatively, the tension in first caliper brake may be less than in the second caliper brake to insure the same result.

### BACKGROUND OF THE INVENTION

1. Field of the Invention

This invention relates to a braking system for controlling the de-acceleration of a bicycle.

2. Background of the Invention

The present invention is an improvement of braking systems for bicycles. The object of most modern bicycle braking systems is to exert differential braking forces on the front and rear wheels of a bicycle. More specifically, it is generally considered preferable that the braking force on the rear tire be less than the braking force on the front tire. This rule arises out of the observation that the rear wheel has a tendency to skid when greater force is applied to the rear wheel than is applied to the front wheel. This sometimes causes the rear wheel to rise off the ground when the rear brake is applied abruptly in emergency situations, which can cause the inexperienced bicyclist to loose control of the vehicle.

It has also been observed that once the rear wheel begins to skid, further actuation of the rear wheel brake has no effect on the forward momentum of the bicycle. Therefore, if one desires to stop the bicycle before the bicycle reaches the end of the skid, it must be done by applying braking force to the front wheel, which is still rotating.

To create a differential braking system, inventors have devised various systems that apply greater braking force to the front wheel than to the rear wheel. Examples of prior art approaches may be found in Watkins, United Kingdom Patent Application 2,153,460A, published on Aug. 21, 1985 wherein Watkins suggests at least four separate strategies, including the utilization of differential tension springs, the use of different sized braking pads, different lengths of caliper arms, or simply actuating the hand lever for the front brake before the rear brake.

In Johnson, U.S. Pat. No. 4,480,720, issued on Nov. 6, 1984, the inventor devised a braking system that includes a relay transmitting system that allows greater braking force to be applied initially to rear wheel, followed by a shift so that greater braking force is thereafter applied to the front wheel. While this approach is sound, it is limited in that it involves a relatively complex mechanical relay mechanism that adds to the difficulty of manufacture and assembly of the bicycle as well as adds a source of potential mechanical brake failure or malfunction.

The present invention is a new solution to the differential braking problem that can easily be added to any bicycle. The improvement comprises a dual braking system for the front wheel. This dual system has a first and second brake caliper, both of which are used for braking of the front wheel. The first and second calipers are secured to separate actuating cables. The actuating cable attached to the first caliper is shorter than the actuating cable attached to the second caliper. The two actuating cables are both secured to a primary cable that interacts with a conventional hand brake lever.

The invention also includes a conventional hand-lever actuated rear bicycle brake. The rear brake and front dual brakes are operated by separate brake levers. When both levers are squeezed, the rear brake engages the rear wheel and the first caliper of the front dual braking system engages the front wheel. As additional tension is applied, the rear wheel locks up and the second caliper engages the front tire thereby apply greater force to the front tire at the moment that the rear wheel is expected to begin skidding. This effectively shortens the stopping distance of the bicycle in critical emergency situations.

### SUMMARY OF THE INVENTION

One of the main objects of the present invention is to provide a means for applying greater braking force to the front tire of a bicycle than is applied to the rear tire;

Another object of the present invention is to provide a means for increasing the braking force on the front tire of a bicycle after the braking force on the rear tire has reached its maximum;

A further object of the invention is to provide a means for applying a graduated increase in the braking pressure on the front tire of a bicycle to provided for more controlled stops.

An additional object of the present invention is to provide a safer bicycle braking system that permits the bicyclist to stop in a shorter distance without the rear wheel rising from the ground.

These and other objects and advantages of the present invention will become apparent from the following detailed description of the preferred embodiment of the invention without intending to limit the scope of the invention which is set forth in the appended claims.

### BRIEF DESCRIPTION OF THE DRAWINGS

The advantages of the invention can be more clearly understood by reference to the drawings in which:

FIG. 1 illustrates an environmental view of a bicycle that has been equipped with the invention;

FIG. 2 illustrates a side elevational view of the invention; and,

FIG. 3 is a cutaway view of a portion of the invention showing the interior of the housing.

### DETAILED DESCRIPTION OF THE PREFERRED EMBODIMENT

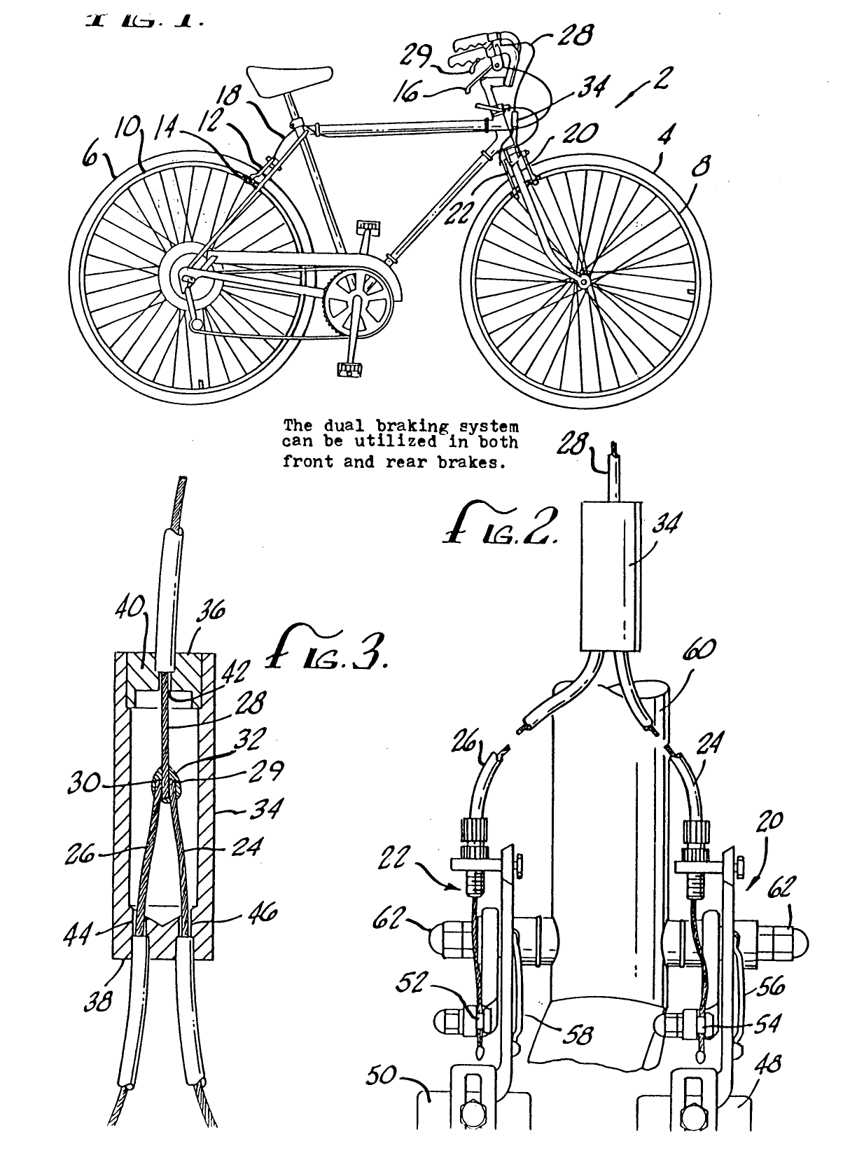

FIG. 1 illustrates a conventional bicycle 2 having a front wheel 4 and a rear wheel 6. Said front and rear wheels having front and rear rim surfaces 8 and 10, respectively. Said rear rim surface is engaged by a rear brake 12 of the conventional spring loaded caliper variety having conventional brake pads 14 (only one shown). The rear brake is controlled by a hand brake lever 16 via a rear brake cable 18. The entire rear brake system is conventional in nature.

The de-acceleration of the rotation of the front wheel 4 is controlled by a dual braking system. The dual braking system is comprised of a first caliper brake 20 and a second caliper brake 22. The first caliper brake 20 is controlled by a short actuating cable 24. The second caliper brake 22 is controlled by a long actuating cable 26. The two actuating cables 24, 26 are referred to as short and long because the length of the short actuating cable 24 is less than that of the long actuating cable 26. The two actuating cables 24, 26 are joined to a primary cable 28. The primary cable has a terminal end 29 to which the two actuating cables 24, 26 attached by weld 30 creating a fork 32. However, the cables can be joined by any conventional means or can be formed from one cable that forks into two cables. The primary cable 28 is secured to a standard hand brake lever 29.

The fork 32 is contained within an elongated housing 34 having a first end 36 and second end 38. A plug 40 fits snugly within the first end 36 of the housing 34. The plug 40 has an aperture 42 through which the primary cable 28 enters the housing 34. The second end 38 has a left aperture 44 and a right aperture 46. The long and short actuating cables 24, 26 exit the housing 34 through the left and right apertures 44, 46. It does not matter which cable 24, 26 exits which aperture 44, 46.

The first caliper brake 20 has a first set of diametrically opposed brake pads 48 (only one shown). The second caliper brake 22 has a second set of diametrically opposed brake pads 50 (only one shown). The first and second set of brake pads 48, 50 are not the same. The first set 48 is thinner than the second set 50. The reason for this is best illustrated by explaining how the invention works.

When the bicyclist squeezes the hand lever 29, tension is applied to the primary cable 28. Tension in the primary cable 28 is first translated into tension in the short actuating cable 24, which causes the contraction of the first caliper brake 20 so as to interact with the rim surface 8. As additional tension is applied to the primary cable 28, tension begins to build in the long actuating cable 26, resulting in contraction of the second caliper brake 22 so as to interact with the rim surface 8 also. However, as the first caliper brake 20 reaches maximum contraction (i.e., when the brake pads 48 are maximally pressed against the rim surface 8), the primary cable 28 is not able to tense any farther. As a consequence, no additional tension will be translated to the long actuating cable 26. Therefore, sufficient tension must be present in the long actuating cable 26 to bring the second caliper brake 22 into contact with the wheel rim 8 before the first caliper brake 20 reaches maximum contraction. this problem may usually be addressed by adjusting the length of the long actuating cable 26.

The objective of insuring that the second brake engages before the short actuating cable reaches maximum tension can also be accomplished by adjusting the tension in the springs of the caliper brakes. The first caliper brake has a conventional first spring 56 which resists the force of the short actuating cable 24, which is standard in bicycle brake systems. The second caliper brake has a second spring 58 which resists the force of the long actuating cable 26. By having greater tension in the first spring relative to the second spring, the same purpose is achieved as that described above involving the different thicknesses of the brake pads 48, 50.

To help insure that this occurs, the brake pads 50 of the second brake 22 are thicker than the brake pads 48 of the first brake 20 so that the brake pads 50 can reach the wheel rim 8 without having to travel as far. If the second set of brake pads 48 have any difficulty reaching the wheel rim 8, then adjustment can be made to the length of the long and short actuating cables 24, 26 via the standard adjustment means 52, 54. Though, one should keep in mind when any adjustment is made that the objective is to have the second brake 22 engage the wheel rim 8 at the point at which the rear brake 12 has halted rotation of the rear wheel 6.

In a second embodiment of the invention, the actuating cables 24, 26 are the same length so that both first and second brakes 20, 22 engage the front tire at the same time. This still allows for greater braking pressure to be applied to the front wheel 4 than is applied to the rear wheel 6, which is the objective of modern bicycle braking systems as previously discussed. In this embodiment, the tension in the first spring 56 can be adjusted to be less than the tension in the second spring 58 so that the first caliper brake 20 will engage the front rim 8 before the second brake 22.

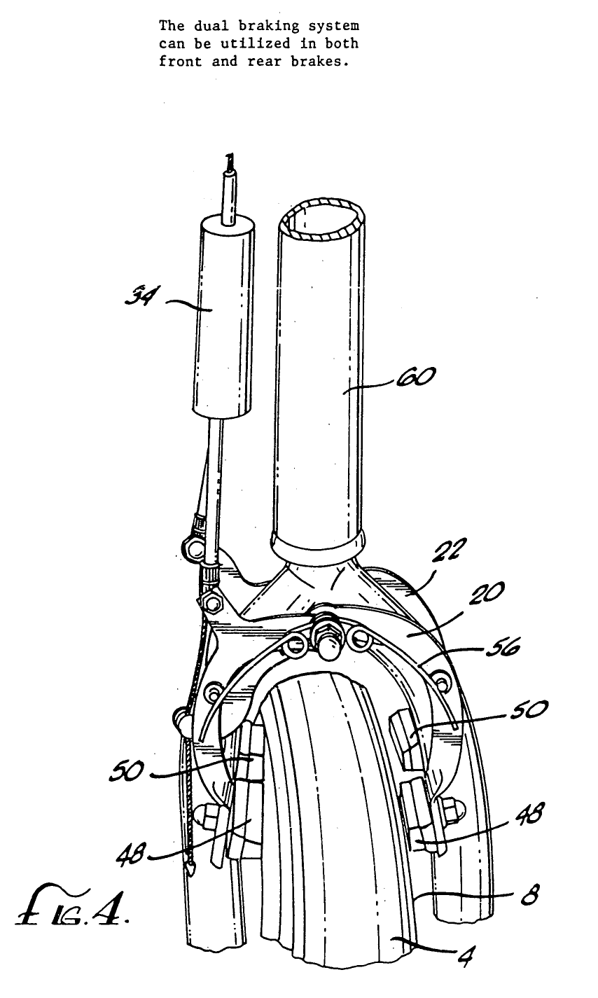

The first and second brakes 20, 22 may be secured to the bicycle by any conventional means. In FIG. 2, this is accomplished by passing a rod (not shown) through frame member 60. The rod is used as the axle for the first and second caliper brakes 20, 22 and the brakes are secured to the rod by nuts 62.

The invention and its attendant advantages will be understood from the foregoing description and it will be apparent that various changes may be made without departing from the spirit of the invention.

I claim:

1. A bicycle braking system for controlling the de-acceleration of a bicycle, said bicycle having at least a front wheel and a rear wheel, each of said wheels having side walls, said wheels secured to a frame, said frame having handle bars comprising:
a first caliper brake and a second caliper brake secured to said bicycle frame, each of said caliper brakes positioned about said front wheel for actively engaging said side walls of said front wheel, said first caliper brake having a first set of diametrically opposed brake pads, said second caliper brake having a second set of diametrically opposed brake pads;
a front brake lever secured;
a primary brake cable engaging said front brake lever, said primary brake cable having a terminal end; and,
a short actuating brake cable and a long actuating cable, said short actuating cable having a length that is less than the length of said long actuating cable, said short and long actuating cables joined to said primary brake cable forming a fork, said short actuating cable engaging said first caliper brake, said long actuating cable engaging said second caliper brake such that operation of said front brake lever causes tension in said primary cable to translate into increased tension in said short actuating cable resulting in the braking action of said first caliper brake before tension in said primary cable is translated to said long actuating cable resulting in the delayed braking action of said second caliper brake.

2. A dual bicycle braking system as in claim 1 wherein said system includes an elongated housing encasing said fork, said housing having a primary cable aperture through which said primary cable enters said housing, said housing having two actuating cable apertures through which said short actuating cable and said long actuating cable separately exit said housing.

3. A dual bicycle braking system as in claim 1 wherein said short and long actuating cables are equal lengths.

4. A dual bicycle braking system as in claim 1 wherein said first caliper brake has a first tension spring and said second caliper brake has a second tension spring, tension in said first tension spring being greater than that in said second tension spring.

5. A dual bicycle braking system as in claim 4 wherein said first set of break pads and second set of brake pads are the same thickness.

6. A bicycle braking system for controlling the de-acceleration of a bicycle, said bicycle having at least a front wheel and a rear wheel, each of said wheels having side walls, said wheels secured to a frame, said frame having handle bars comprising:
a first caliper brake and a second caliper brake secured to said bicycle frame, each of said caliper brakes positioned about said front wheel for actively engaging said side walls of said front wheel, said first caliper brake having a first set of diametrically opposed brake pads, said second caliper brake having a second set of diametrically opposed brake pads;
a front brake lever secured to said handle bars of said bicycle for controlling the rotation of said front wheel;
a rear brake lever secured to said handle bars of said bicycle for controlling the rotation of said rear wheel, said rear brake lever engaging a rear brake cable, said rear brake cable secured to a rear caliper brake positioned to engage said side walls of said rear wheel;
a primary brake cable engaging said front brake lever, said primary brake cable having a terminal end;
a short actuating brake cable and a long actuating cable, said short actuating cable having a length that is less than the length of said long actuating cable, said short and long actuating cables joined to said primary brake cable forming a fork, said short actuating cable engaging said first caliper brake, said long actuating cable engaging said second caliper brake such that operation of said front brake lever causes tension in said primary cable to translate into increased tension in said short actuating cable resulting in the braking action of said first caliper brake before tension in said primary cable is translated to said long actuating cable resulting in the delayed braking action of said second caliper brake; and,
an elongated housing encasing said fork, said housing having a primary cable aperture through which said primary cable enters said housing, said housing having two actuating cable apertures through which said short actuating cable and said long actuating cable separately exit said housing.

7. A dual bicycle braking system as in claim 6 wherein operation of said front brake lever and said rear brake lever simultaneously causes the said first caliper brake to engage said front wheel rim at the same moment as said rear caliper brake engages said rear wheel rim.

8. A dual bicycle braking system as in claim 6 wherein said short and long actuating cables are equal lengths.

9. A dual bicycle braking system as in claim 6 wherein said first caliper brake has a first tension spring and said second caliper brake has a second tension spring, tension in said first tension spring being greater than that in said second tension spring.

10. A dual bicycle braking system as in claim 6 wherein said first set of break pads is thinner than said second set of brake pads.

11. A bicycle braking system for controlling the de-acceleration of a bicycle, said bicycle having at least a front wheel and a rear wheel, each of said wheels having side walls, said wheels secured to a frame, said frame having handle bars comprising:
a first caliper brake and a second caliper brake secured to said bicycle frame, each of said caliper brakes positioned about said front wheel for actively engaging said side walls of said front wheel, said first caliper brake having a first set of diametrically opposed brake pads, said second caliper brake having a second set of diametrically opposed brake pads;
a front brake lever secured to said handle bars of said bicycle for controlling the rotation of said front wheel;
a rear brake lever secured to said handle bars of said bicycle for controlling the rotation of said rear wheel, said rear brake lever engaging a rear brake cable, said rear brake cable secured to a rear caliper brake positioned to engage said side walls of said rear wheel;
a primary brake cable engaging said front brake lever, said primary brake cable having a terminal end; and,
a first actuating brake cable and a second actuating cable, said first actuating cable having a length equal to the length of said second actuating cable, said first and second actuating cables joined to said primary brake cable forming a fork, said first actuating cable engaging said first caliper brake, said second actuating cable engaging said second caliper brake such that operation of said front brake lever causes tension in said primary cable to translate into increased tension in said first and second actuating cables resulting in simultaneous braking action of said first caliper brake and said second caliper brake.

12. A dual bicycle braking system as in claim 11 wherein an elongated housing encases said fork, said housing having a primary cable aperture through which said primary cable enters said housing, said housing having two actuating cable apertures through which said first actuating cable and said second actuating cable separately exit said housing.

13. A dual bicycle braking system as in claim 11 wherein operation of said front brake lever and said rear brake lever simultaneously causes the said first and second caliper brakes to engage said front wheel rim at the same moment as said rear caliper brake engages said rear wheel rim.

14. A dual bicycle braking system as in claim 11 wherein said first caliper brake has a first tension spring and said second caliper brake has a second tension spring, tension in said first tension spring being less than that in said second tension spring.
